(19) United States
(12) Patent Application Publication
(10) Pub. No.: US 2013/0121683 A1
(43) Pub. Date: May 16, 2013

(54) APPARATUS AND METHOD FOR DETERMINING A LOCATION OF FAILURE IN A TRANSMISSION NETWORK

(71) Applicant: Fujitsu Limited, Kawasaki (JP)

(72) Inventor: Kazuaki NAGAMINE, Ota (JP)

(73) Assignee: Fujitsu Limited, Kawasaki (JP)

(21) Appl. No.: 13/651,773

(22) Filed: Oct. 15, 2012

(30) Foreign Application Priority Data
Nov. 11, 2011 (JP) 2011-247970

(51) Int. Cl. H04B 10/08

(52) U.S. Cl. 398/2; 398/10

(57) ABSTRACT

A plurality of transmission devices are communicably coupled to each other in a first transmission network. A first transmission device receives data from a second transmission device, and extracts, from the received data, attribute information including report-destination identification information identifying a third transmission device and routing information identifying a transmission route through which the data has been transmitted to the first transmission device via the second transmission device in the first transmission network. The first transmission device stores the extracted attribute information in a memory, and notifies, upon detecting a failure that has occurred in the first transmission network, the third transmission device of failure information that indicates an occurrence of the failure and includes the route information, based on the report-destination identification information included in the attribute information stored in the memory, through a second transmission network different from the first transmission network.

### CROSS-REFERENCE TO RELATED APPLICATION

This application is based upon and claims the benefit of priority of the prior Japanese Patent Application No. 2011-247970, filed on Nov. 11, 2011, the entire contents of which are incorporated herein by reference.

### FIELD

The embodiments discussed herein are related to an apparatus and method for determining a location of failure in a transmission network.

### BACKGROUND

In an Optical Transport Network (OTN), a plurality of transmission apparatuses are connected such that data communication is allowed between the transmission apparatuses. An Operation System (OPS) server centrally manages the OTN as to operation status of each transmission apparatus on the OTN. When a line failure occurs in the OTN, the OPS server sequentially inquires the failure status of the transmission apparatuses on the OTN and collects responses to the inquiry from the transmission apparatuses.

The OPS server identifies a location of the failure on the OTN based on the responses of the transmission apparatuses to the inquiry from the OPS server. When the location of the failure is identified, the OPS server searches for an alternative route that bypasses the location of the failure. When the alternative route is found, a maintenance engineer manually switches the currently-used route to the alternative route to make recovery from the failure.

Descriptions of techniques associated with the OTN may be found, for example, in Japanese Laid-open Patent Publication No. 5-122184, Japanese Laid-open Patent Publication No. 7-231353, and Japanese Laid-open Patent Publication No. 2011-114526.

### SUMMARY

According to an aspect of the invention, a plurality of transmission devices are communicably coupled to each other through a first transmission network. A first transmission device receives data from a second transmission device, and extracts, from the received data, attribute information including report-destination identification information identifying a third transmission device and routing information identifying a transmission route through which the data has been transmitted to the first transmission device via the second transmission device in the first transmission network. The first transmission device stores the extracted attribute information in a memory, and notifies, upon detecting a failure that has occurred in the first transmission network, the third transmission device of failure information that indicates an occurrence of the failure and includes the route information, based on the report-destination identification information included in the attribute information stored in the memory, through a second transmission network different from the first transmission network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of an optical transmission system, according to a first embodiment;

FIG. 2 is a diagram illustrating a configuration example of a transmission apparatus, according to an embodiment;

FIG. 3 is a diagram illustrating an example of an optical channel data unit (ODU)k frame structure, according to an embodiment;

FIG. 4 is a diagram illustrating an example of an operation of an optical transmission system when a failure has occurred, according to a first embodiment;

FIG. 5 is a diagram illustrating an example of an operation of an optical transmission system when a failure has recovered, according to a first embodiment;

FIG. 6 is a diagram illustrating a configuration example of an optical transmission system, according to a second embodiment;

FIG. 7 is a diagram illustrating an example of an operation of an optical transmission system when a failure has occurred, according to a second embodiment;

FIG. 8 is a diagram illustrating an example of an operation of an optical transmission system when a failure has recovered, according to a second embodiment;

FIG. 9 is a diagram illustrating a configuration example of an optical transmission system, according to a third embodiment; and

FIG. 10 is a diagram illustrating a configuration example of an optical transmission system, according to a fourth embodiment.

### DESCRIPTION OF EMBODIMENTS

However, in the above described system, because the identifying of the failure location on the OTN is performed by the OPS by sequentially inquiring the failure status of the transmission apparatuses on the OTN, a large processing load is imposed on the OPS to identify the failure location.

Embodiments of a transmission apparatus, a transmission method, and a transmission system are described in detail below with reference to drawings. Note that the embodiments described below are given for illustration but not for limitation. Note that techniques disclosed in the embodiments may be combined properly as long as no conflict occurs.

### First Embodiment

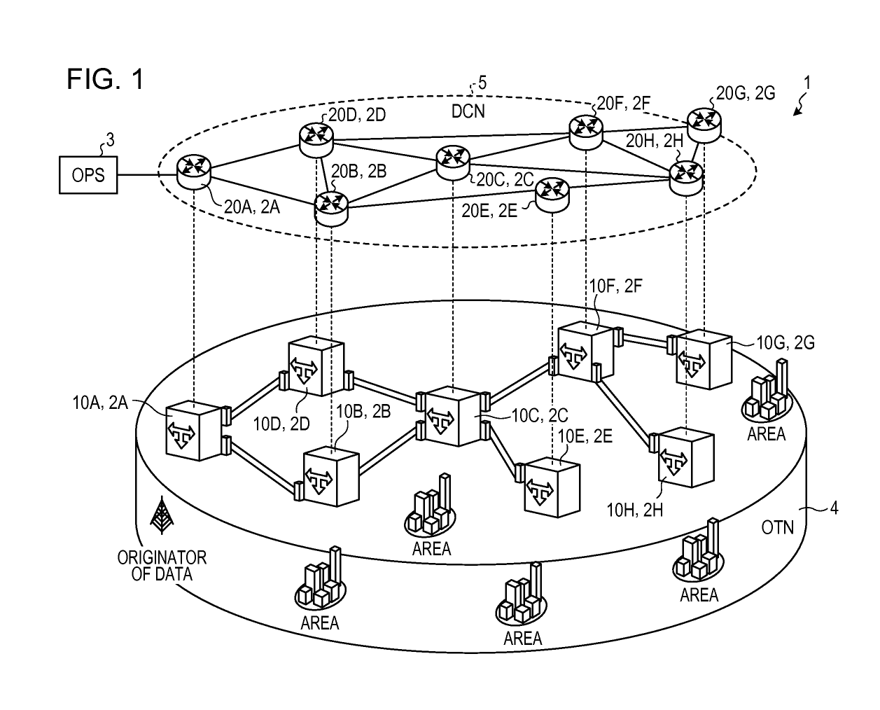

FIG. 1 is a diagram illustrating a configuration example of an optical transmission system, according to a first embodiment. The optical transmission system 1 illustrated in FIG. 1 includes a plurality of transmission apparatuses 2, an Operation System (OPS) server 3, an Optical Transport Network (OTN) 4, and a Data Communication Network (DCN) 5. The transmission apparatuses 2 are assumed to be installed in various areas. The OTN 4 includes the plurality of transmission apparatuses 2 which are connected such that the respective transmission apparatuses 2 are allowed to communicate with each other. The provision of the DCN 5 allows communication for monitor/control operation to be performed between transmission apparatuses 2 and between transmission apparatuses 2 and the OPS server 3.

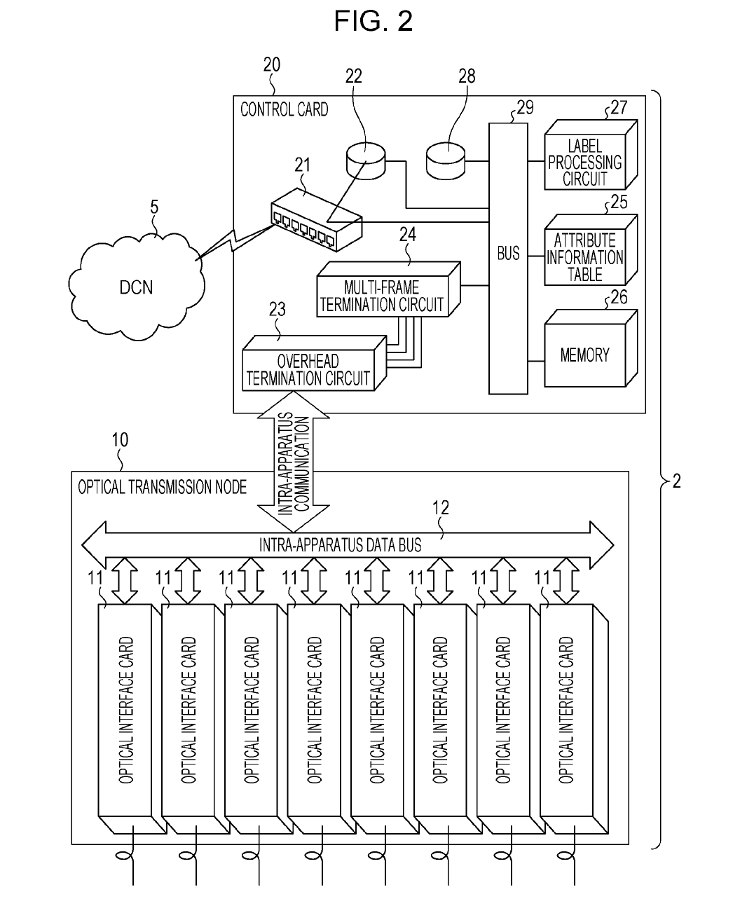

FIG. 2 is a diagram illustrating a configuration example of a transmission apparatus, according to an embodiment. In the example illustrated in FIG. 2, the transmission apparatus 2 includes an optical transmission node 10 and a control card 20. The optical transmission node 10 serves as a communication interface with the OTN 4. The control card 20 controls the whole transmission apparatus 2 and also functions as a communication interface with the DCN 5. In FIG. 1, for convenience of illustration, transmission apparatuses 2 are denoted by suffixes A to H following 2 such as a transmission apparatus 2A and a transmission apparatus 2B. Similarly, corresponding respective optical transmission nodes 10 are denoted by suffixes A to H following 10, such as an optical transmission node 10A and an optical transmission node 10B, and corresponding respective control cards 20 are denoted by suffixes A to H following 20, such as a control card 20A and a control card 20B. In other words, the transmission apparatus 2A includes the optical transmission node 10A and the control card 20A, and the transmission apparatus 2B includes the optical transmission node 10B and the control card 20B, and so on. Note that the transmission apparatus 2A, the transmission apparatus 2B, and so on will be also referred to as #A, #B, and so on, respectively, for simplicity.

The optical transmission node 10 includes a plurality of optical interface cards 11 and an intra-apparatus data bus 12. The optical interface card 11 functions as a communication interface with, for example, the OTN 4. The optical interface card 11 transmits/receives main signal frames via the intra-apparatus data bus 12. Communication between the optical interface card 11 and the control card 20 is performed via the intra-apparatus data bus 12.

The control card 20 includes a communication device 21, a routing table 22, an overhead termination circuit 23, and a multi-frame termination circuit 24. The control card 20 further includes an attribute information table (label table) 25, a memory 26, a label processing circuit 27, a failure alarm data base (DB) 28, and a bus 29. The communication device 21 functions as an interface for communication with the DCN 5. The routing table 22 is a table in which pieces of information on transmission routes on the OTN 4 are stored. The overhead termination circuit 23 is connected to the intra-apparatus data bus 12 in the optical transmission node 10 and terminates a main signal frame received via the intra-apparatus data bus 12. The multi-frame termination circuit 24 extracts an overhead (OH) from the main signal frame terminated by the overhead termination circuit 23. The attribute information table 25 manages an IP address of the transmission apparatus 2 defined on the DCN 5 and a circuit ID identifying the optical interface card 11 of the transmission apparatus 2 on the OTN 4. The memory 26 stores various kinds of information.

The label processing circuit 27 controls the whole control card 20. The label processing circuit 27 extracts line attribute information attached to an overhead of a main signal frame transmitted from an upstream transmission apparatus 2 on the OTN 4, and the label processing circuit 27 updates attribute information in the memory 26 by overwriting the attribute information in the memory 26 with the extracted attribute information. Note that the attribute information attached to the main signal frame includes an IP address on the DCN 5 assigned to a transmission apparatus 2 to which a report on failure is to be sent (hereinafter, such a transmission apparatus 2 will be referred to simply as a report-destination transmission apparatus 2), and a circuit ID of the report-destination transmission apparatus 2 defined on the OTN 4, and route information identifying a transmission route of the main signal frame on the OTN 4. Note that the report-destination transmission apparatus 2 is a transmission apparatus 2 specified as an apparatus to which a failure alarm is to be sent when a failure is detected. For example, the report-destination transmission apparatus 2 is a transmission apparatus 2A (#A) including an ingress optical transmission node 10A that has originated a main signal frame. The route information identifies a transmission route along which the main signal frame is transmitted from the ingress optical transmission node 10A to a closest upstream optical transmission node 10, where the transmission route is represented by address information identifying transmission apparatuses 2 that are located on the transmission route. For example, in a case of attribute information extracted by the control card 20C in the transmission apparatus 2C, the attribute information includes information indicating an IP address, defined on the DCN 5, of the transmission apparatus 2A specified as the report-destination transmission apparatus 2 and a circuit ID, defined on the OTN 4, of the transmission apparatus 2A, and also includes route information identifying a route #A→#B.

When a main signal frame is transmitted to an optical transmission node 10 of a downstream transmission apparatus 2 on the OTN 4, the label processing circuit 27 produces new attribute information by adding the transmission apparatus 2 as a node on the way (hereinafter referred to simply as a way node) to the route information in the updated attribute information stored in the memory 26. Furthermore, the label processing circuit 27 adds the new attribute information to the overhead. For example, in a case where the transmission apparatus 2C transmits a main signal frame to the transmission apparatus 2F at a downstream location, the attribute information of the main signal frame is produced such that no change is made on the IP address and the circuit ID of the transmission apparatus 2A functioning as the report-destination transmission apparatus 2, while #C is added as a way node to the route information and thus the resultant route information identifies a route #A→#B→#C. The multi-frame termination circuit 24 attaches the overhead including the new attribute information to the main signal frame and transmits the main signal frame to the optical transmission node 10. The optical transmission node 10C of the transmission apparatus 2C transmits the main signal frame to the transmission apparatus 2F and transmission apparatus 2E at downstream locations on the OTN 4.

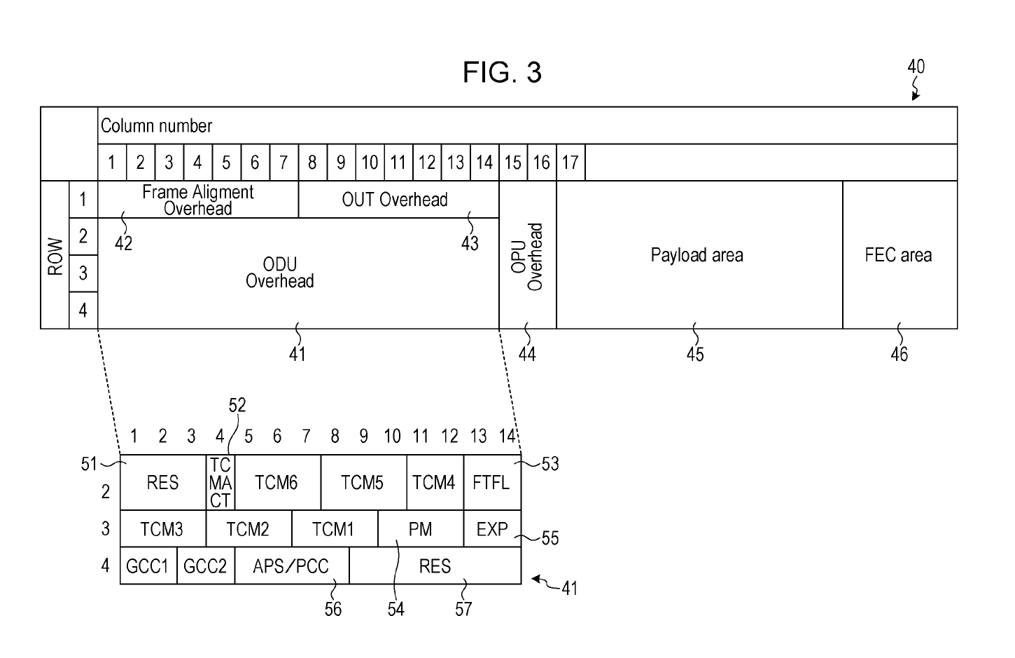

FIG. 3 is a diagram illustrating an example of an optical channel data unit (ODU)k frame structure, according to an embodiment. In FIG. 3, ODUk 40 denotes a frame structure according to the International Telecommunication Union Telecommunication Standardization Sector (ITU-T) G.709 standard. The ODUk 40 includes an ODU overhead 41, a frame alignment overhead 42, an Optical channel Transport Unit (OTU) overhead 43, and an Optical channel Payload Unit (OPU) overhead 44. Furthermore, the ODUk 40 also includes a Payload area 45 and an Forward Error Correction (FEC) area 46. The ODU overhead 41 includes Reserve (RES) field 51, Tandem Connection Monitoring (TCM) ACT 52, and TCM 1 to TCM 6. RES 51 is a reserved field of bytes. TCM 1 to TCM 6 are fields of bytes for tandem connection monitoring.

The ODU overhead 41 includes Fault Type and Fault Location Reporting channel (FTFL) 53, Path Monitoring (PM) 54, Experimental (EXP) 55, General Communication Channel (GCC) 1, and GCC2. FTFL 53 is a field of bytes indicating a failure type and a failure location. PM 54 is a field of bytes for path monitoring. EXP 55 is a field of bytes for experiment. GCC1 and GCC2 are bytes indicating general-purpose communication channels. The ODU overhead 41 further includes Automatic Protection Switching coordination channel (APS)/Protection Communication Control channel (PCC) 56 and RES 57. APS/PCC 56 is a field of bytes indicating automatic protection switching/protection communication channels. RES 57 is a reserved field of bytes. Note that the attribute information may be stored in RES 57.

When the label processing circuit 27 detects a failure on the OTN 4, the label processing circuit 27 sends a failure alarm to the report-destination transmission apparatus 2, using a trap function of Simple Network Management Protocol (SNMP) of the DCN 5. The failure alarm includes a circuit ID of an optical transmission node 10 that has detected the failure, failure information indicating the details of the failure, and route information stored in the updated attribute information overwritten in the memory 26. That is, the label processing circuit 27 sends the failure alarm to the report-destination transmission apparatus 2 using the SNMP trap function based on the IP address described in the updated attribute information overwritten in the memory 26.

When the label processing circuit 27 in the control card 20 of the report-destination transmission apparatus 2 receives the failure alarm from a downstream transmission apparatus 2 using the SNMP trap function, the label processing circuit 27 registers the received failure alarm in the failure alarm DB 28. Furthermore, the label processing circuit 27 identifies a location of the failure on the OTN 4 based on the failure alarm indicating the circuit ID of the optical transmission node 10 that has detected the failure, the route information, and the details of the failure. In the identification of the location of the failure on the OTN 4, in addition to the contents of the above-described failure alarm, the label processing circuit 27 may take into account a failure alarm given from another transmission apparatus 2.

Furthermore, the label processing circuit 27 of the report-destination transmission apparatus 2 determines, based on the contents of the failure alarm, what is to be performed to make recovery from the failure, and issues a command to make recovery from the failure according to the result of the determination. Hereinafter, expression “recovery from a failure” will be used to mean that the failure is resolved by using an alternative transmission route. For example, in a case where the location of the failure is on a line between the optical transmission node 10B and the optical transmission node 10C, the label processing circuit 27 refers to the contents of a routing table 22 and determines that the currently-used route is to be changed to an alternative route #A→#D→#C for recovery from the failure. As a result, the optical transmission node 10C receives a main signal frame from the optical transmission node 10D via the alternative route, and thus the recovery from the failure is achieved. Alternatively, the label processing circuit 27 may issue a command to change the route using a protection switching function, or may issue a command to dynamically change the route using Open Shortest Path First (OSPF)—Traffic Engineering (TE).

In a case where a failure occurs as a result of disabling the FEC correction at a transmission apparatus 2, the label processing circuit 27 commands this transmission apparatus 2 with the failure to enable the FEC correction. In this way, the transmission apparatus 2 with the failure is allowed to make recovery from the failure by enabling the FEC correction.

Once the recovery from the line failure is made, the optical transmission node 10 of the transmission apparatus 2 that has issued the failure alarm becomes capable of receiving a main signal frame from an upstream optical transmission node 10. Furthermore, the label processing circuit 27 in the control card 20 extracts attribute information from an overhead of the received main signal frame via a multi-frame termination circuit 24. The label processing circuit 27 updates attribute information in the memory 26 by overwriting the attribute information in the memory 26 with the extracted attribute information. The label processing circuit 27 then notifies the report-destination transmission apparatus 2 of recovery-from-failure information indicating recovery from the failure, using the SNMP trap function. The recovery-from-failure information includes the circuit ID of the optical transmission node 10 in the transmission apparatus 2 that has issued the failure alarm and recovery information indicating completion of the recovery from the failure. The label processing circuit 27 notifies the report-destination transmission apparatus 2 of the recovery-from-failure information using the SNMP trap function, based on the IP address of the report-destination transmission apparatus 2 described in the updated attribute information overwritten in the memory 26.

When the label processing circuit 27 of the report-destination transmission apparatus 2 receives the recovery-from-failure information using the SNMP trap function via the DCN 5, the label processing circuit 27 deletes information on the failure alarm registered in the failure alarm DB 28. As a result, the report-destination transmission apparatus 2 recognizes that the recovering from the failure on the OTN 4 is complete.

The communication device 21, the routing table 22, the multi-frame termination circuit 24, the attribute information table 25, the memory 26, the label processing circuit 27, and the failure alarm DB 28 are configured to transmit/receive data via the bus 29.

Next, an operation of the optical transmission system 1 according to the first embodiment will be described.

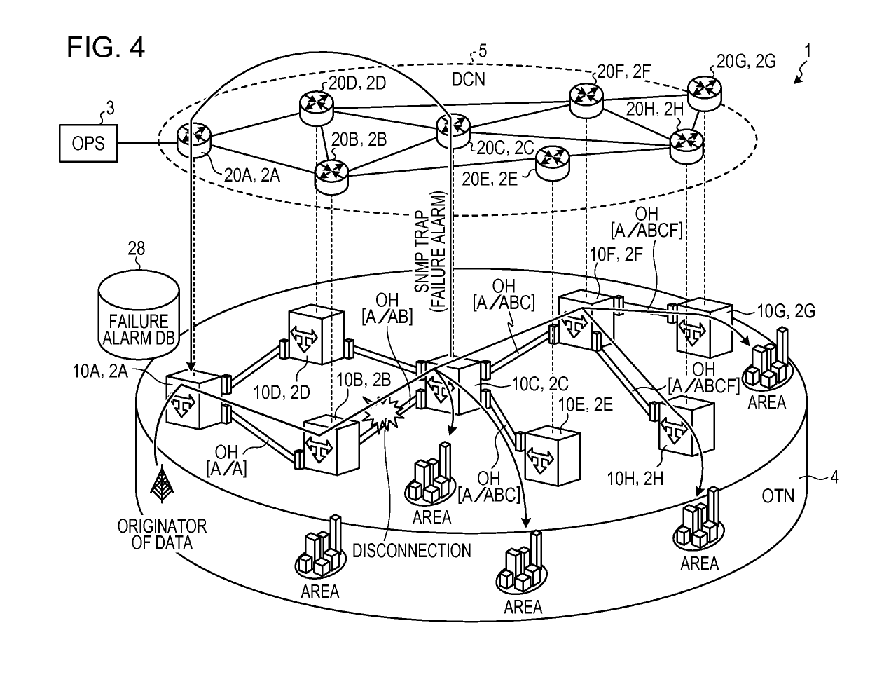

FIG. 4 is a diagram illustrating an example of an operation of an optical transmission system when a failure has occurred, according to a first embodiment. FIG. 4 illustrates an operation in a state where a failure alarm has been issued. In the example illustrated in FIG. 4, the transmission apparatus 2A including the optical transmission node 10A serves as an ingress transmission apparatus 2, and a main signal frame is unidirectionally transmitted from the optical transmission node 10A to a downstream optical transmission node 10. That is, the main signal frame is transmitted along a route: optical transmission node 10A (#A)→optical transmission node 10B (#B)→optical transmission node 10C (#C)→. . .

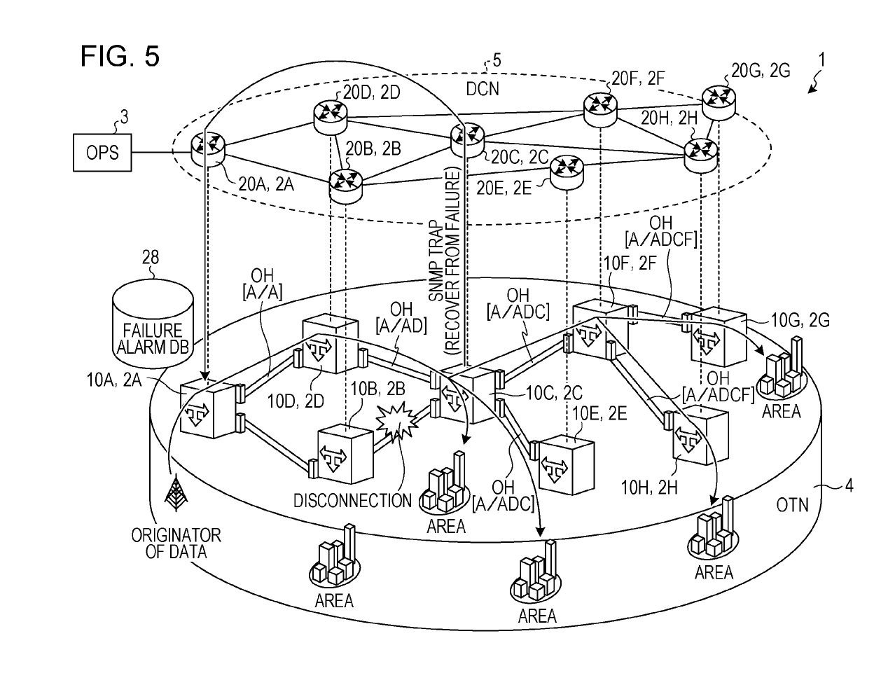

In FIG. 4, the optical transmission node 10A of the transmission apparatus 2A transmits a main signal frame to which attribute information is attached to the optical transmission node 10B of the transmission apparatus 2B, where the attribute information includes an IP address on the DCN 5 and a circuit ID on the OTN 4 of the transmission apparatus 2A and route information for the transmission apparatus 2A. The attribution information is conveyed by an over head (OH) field in the main signal frame, and expressed as “OH [report-destination identification information/route information]” in FIG. 5. Here, report-destination identification information is information identifying a report-destination transmission device, and, for example, the IP address on the DCN 5 and the circuit ID on the OTN 4 defined for the report-destination transmission apparatus 2 are used as the report-destination identification information. Route information is information identifying a transmission route of the main signal frame, and, for example, the route information is represented as a sequence of identifiers each identifying an optical transmission node via which the main signal frame is transmitted in the OTN 4. In FIG. 4, for example, attribution information OH [A/ABC] indicates that report-destination identification information is “A” identifying the transmission apparatus 2A and route information is “ABC” identifying the transmission route: optical transmission node 10A (#A)→optical transmission node 10B (#B)→optical transmission node 10C (#C).

When the transmission apparatus 2B receives the main signal frame from the optical transmission node 10A, the transmission apparatus 2B updates attribute information in the memory 26 by overwriting the attribute information in the memory 26 with the attribution information attached to the main signal frame. Further, when the transmission apparatus 2B transmits the main signal frame to a downstream transmission apparatus 2 on the OTN 4, the transmission apparatus 2B rewrites the route information in the attribute information by adding the transmission apparatus 2B (#B) as a way node to the route information, to produce new attribute information including route information identifying a transmission route #A→#B. Note that the attribute information is produced such that the report-destination ID, that is, the IP address on the DCN 5 and the circuit ID on the OTN 4 defined for the report-destination transmission apparatus 2 are maintained without being changed. The optical transmission node 10B of the transmission apparatus 2B transmits the main signal frame to which the new attribute information is attached (as denoted by attribution information OH [A/AB] in FIG. 4) to the optical transmission node 10C of the transmission apparatus 2C.

When the transmission apparatus 2C receives the main signal frame from the optical transmission node 10B, the transmission apparatus 2C updates attribute information in the memory 26 by overwriting the attribute information in the memory 26 with the attribute information attached to the main signal frame. When the transmission apparatus 2C transmits the main signal frame to a downstream transmission apparatus 2 on the OTN 4, the transmission apparatus 2C rewrites the route information in the attribute information by adding the transmission apparatus 2C (#C) as a way node to the route information, to produce new attribute information including route information indicating a route #A→#B→#C (as denoted by attribution information OH [A/ABC] in FIG. 4). The optical transmission node 10C of the transmission apparatus 2C then transmits the main signal frame to which the new attribute information is attached to the optical transmission node 10E and the optical transmission node 10F.

When the transmission apparatus 2F receives the main signal frame from the optical transmission node 10C, the transmission apparatus 2F updates attribute information in the memory 26 by overwriting the attribute information in the memory 26 with the attribute information attached to the main signal frame. When the transmission apparatus 2F transmits the main signal frame to a downstream transmission apparatus 2 on the OTN 4, the transmission apparatus 2F rewrites the route information in the attribute information by adding the transmission apparatus 2F (#F) as a way node to the route information, to produce new attribute information including route information indicating a route #A→#B→#C→#F (as denoted by attribution information OH [A/ABCF] in FIG. 4). The optical transmission node 10F of the transmission apparatus 2F then transmits the main signal frame to which the new attribute information is attached to the optical transmission node 10G and the optical transmission node 10H. Note that the transmission apparatus 2G and the transmission apparatus 2H operate in a similar manner.

In a case where the transmission apparatus 2C detects, as a failure, a line disconnection between the optical transmission node 10B and the optical transmission node 10C, the transmission apparatus 2C acquires the IP address, defined on the DCN 5, of the report-destination transmission apparatus 2A from the updated attribute information rewritten in the memory 26. The control card 20C of the transmission apparatus 2C sends a failure alarm to the control card 20A of the report-destination transmission apparatus 2A via the DCN 5 using the SNMP trap function, based on the IP address, defined on the DCN 5, of the report-destination transmission apparatus 2A. The failure alarm includes the circuit ID of the optical transmission node 10 that has detected the failure, the route information stored in the attribute information, and information indicating details of the failure.

The report-destination transmission apparatus 2A receives the failure alarm from the transmission apparatus 2C via the DCN 5 using the SNMP trap function. When the transmission apparatus 2A receives the failure alarm, the transmission apparatus 2A registers information on the failure alarm in the failure alarm DB 28. Based on the information indicating details of the failure described in the failure alarm, information identifying the optical transmission node 10 that has detected the failure, and the route information, the transmission apparatus 2A identifies the location of the failure on the OTN 4. For example, it is determined that the failure has occurred on the line between the optical transmission node 10B and the optical transmission node 10C.

When the location of the failure is identified, the report-destination transmission apparatus 2A refers to the content of the routing table 22 and issues a command to change the currently-used route to an alternative route that bypasses the location of the failure between the optical transmission node 10B and the optical transmission node 10C and that allows the transmission apparatus 2A to transmit the main signal frame to the optical transmission node 10C via the optical transmission node 10D.

FIG. 5 is a diagram illustrating an example of an operation of an optical transmission system when a failure has recovered, according to a first embodiment. In this case, expression “recovery from a failure” is used to mean that the failure is resolved by using an alternative transmission route. In FIG. 5, the report-destination transmission apparatus 2A resolves the failure by replacing the optical transmission node 10B on the OTN 4 with the optical transmission node 10D such that it becomes possible to transmit the main signal frame to the optical transmission node 10C via the optical transmission node 10D. The report-destination transmission apparatus 2A generates attribute information including, as report-destination identification information, the IP address on the DCN 5 and the circuit ID on the OTN 4 which are assigned to the transmission apparatus 2A, and route information of #A. The transmission apparatus 2A then transmits the main signal frame to which the generated attribute information is attached to the optical transmission node 10D of the transmission apparatus 2D.

When the transmission apparatus 2D receives the main signal frame from the optical transmission node 10A, the transmission apparatus 2D update attribute information in the memory 26 by overwriting the attribute information in the memory 26 with the attribute information attached to the main signal frame. When the transmission apparatus 2D transmits the main signal frame to a downstream transmission apparatus 2 on the OTN 4, the transmission apparatus 2D rewrites the route information in the attribute information by adding the transmission apparatus 2D (#D) as a way node to the route information, to produce new attribute information including route information indicating a route #A→#D (as denoted by attribution information OH [A/AD] in FIG. 4). The optical transmission node 10D in the transmission apparatus 2D then transmits the main signal frame to which the new attribute information is attached, to the optical transmission node 10C of the transmission apparatus 2C.

When the transmission apparatus 2C receives the main signal frame from the optical transmission node 10D, the transmission apparatus 2C updates attribute information in the memory 26 by overwriting the attribute information in the memory 26 with the attribute information attached to the main signal frame. When the transmission apparatus 2D receives the main signal frame from an upstream transmission apparatus 2, the transmission apparatus 2D recognizes that the recovery from the failure is achieved, and the transmission apparatus 2D sends a recovery-from-failure message to the report-destination transmission apparatus 2A using the SNMP trap function based on the IP address, on the DCN 5, of the report-destination transmission apparatus 2A described in the attribute information. When the transmission apparatus 2C transmits the main signal frame to a downstream transmission apparatus 2 on the OTN 4, the transmission apparatus 2C rewrites the route information in the attribute information by adding information identifying the transmission apparatus 2C (#C) as a way node to the route information, to produce new attribute information including route information identifying route #A→#D→#C (as denoted by attribution information OH [A/ADC] in FIG. 4). The optical transmission node 10C in the transmission apparatus 2C then transmits the main signal frame to which the new attribute information is attached, to the optical transmission node 10E and the optical transmission node 10F.

When the report-destination transmission apparatus 2 receives the recovery-from-failure message from the downstream transmission apparatus 2C via the DCN 5 using the SNMP trap function, the report-destination transmission apparatus 2 deletes information on the failure alarm registered in the failure alarm DB 28. As a result, the report-destination transmission apparatus 2 recognizes that the recovering from the failure on the OTN 4 is complete.

When the transmission apparatus 2F receives the main signal frame from the optical transmission node 10C, the transmission apparatus 2F updates attribute information in the memory 26 by overwriting the attribute information in the memory 26 with the attribute information attached to the main signal frame. When the transmission apparatus 2F transmits the main signal frame to a downstream transmission apparatus 2 on the OTN 4, the transmission apparatus 2F rewrites the route information in the attribute information by adding the transmission apparatus 2F (#F) as a way node to the route information, to produce new attribute information including route information indicating a route #A→#D→#C→#F (as denoted by attribution information OH [A/ADCF] in FIG. 4). The optical transmission node 1OF in the transmission apparatus 2F then transmits the main signal frame to which the new attribute information is attached, to the optical transmission node 10G and the optical transmission node 10H. Note that the transmission apparatus 2G and the transmission apparatus 2H operate in a similar manner.

In the first embodiment, when a failure on the OTN 4 is detected, a transmission apparatus that has detected the failure sends a failure alarm to a report-destination transmission apparatus 2, i.e., a transmission apparatus 2 that has originated the main signal frame (the originator of the main signal frame), using the SNMP trap function via the DCN 5. As a result, the report-destination transmission apparatus 2 receives the failure alarm from a downstream transmission apparatus 2 via the DCN 5 and thus it is possible to detect an occurrence of a failure even in a state in which only one-way communication is allowed between transmission apparatuses 2. When a transmission apparatus 2 detects a failure, a failure alarm is autonomously sent to a report-destination transmission apparatus 2 at an upstream location. This allows a reduction in processing load imposed on the OPS 3.

In the first embodiment, the failure alarm includes the circuit ID of the transmission apparatus 2 which has detected the failure, route information, and information indicating details of the failure. Thus, the report-destination transmission apparatus 2 is allowed to identify the location of the failure on the OTN 4, based on the failure alarm including the circuit ID of the transmission apparatus 2 which has detected the failure and the route information.

In the first embodiment, when the location of the failure on the OTN 4 is identified, the report-destination transmission apparatus 2 autonomously issues a command to make recovery from the failure at the identified location of the failure, so as to achieve recovery from the failure. This allows a reduction in operation load in terms of failure recovery imposed on a maintenance engineer.

Furthermore, in the first embodiment, all failure alarm messages are sent to the report-destination transmission apparatus 2, and thus it is sufficient for the OPS 3 to monitor the report-destination transmission apparatus 2, which results in a reduction in processing load imposed on the OPS 3. Furthermore, it becomes unnecessary to periodically perform polling communication between the OPS 3 and the transmission apparatuses 2 in a normal state, which results in a reduction in communication resource in the DCN 5.

In the first embodiment, when a failure on the OTN 4 is detected, a transmission apparatus 2 that has detected the failure sends a failure alarm, using the SNMP trap function, to a report-destination transmission apparatus 2 at an upstream location via the DCN 5, that is, to the transmission apparatus 2A that is the originator of the main signal frame.

### Second Embodiment

The report-destination transmission apparatus 2 is not limited to a transmission apparatus 2A that is the originator of a main signal frame, but any transmission apparatus 2 having a capability of making recovery from a failure may be employed as the report-destination transmission apparatus 2, which will be described below as a second embodiment.

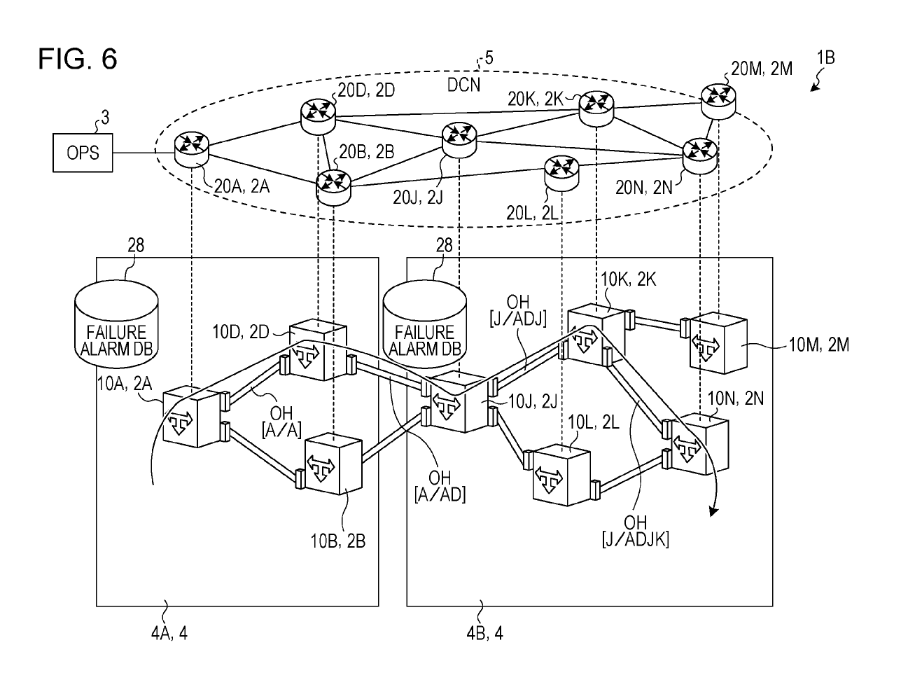

FIG. 6 is a diagram illustrating a configuration example of an optical transmission system, according to a second embodiment. Constituent elements similar to those in the optical transmission system 1 according to the first embodiment are denoted by similar reference numerals or symbols, and a duplicated explanation thereof is omitted here.

In the optical transmission system 1B illustrated in FIG. 6, the OTN 4 is divided into two areas, i.e., an area 4A and an area 4B. A transmission apparatus 2A, a transmission apparatus 2B, and a transmission apparatus 2D are installed in the area 4A. In the area 4B, a transmission apparatus 2J (#J), a transmission apparatus 2K (#K), a transmission apparatus 2L (#L), a transmission apparatus 2M (#M), and a transmission apparatus 2N (#N) are installed. For convenience of illustration, an optical transmission node 10 of the transmission apparatus 2J is also denoted simply by 10J, and a control card 20 of the transmission apparatus 2J is also denoted simply by 20J. Optical transmission nodes 10 and control cards 20 in #K to #N are also denoted in a similar manner.

For example, in the area 4A, the transmission apparatus 2A may operate as a report-destination transmission apparatus 2, while in the area 4B the transmission apparatus 2J having the capability of making recovery from failures may operate as a report-destination transmission apparatus 2.

In this situation, when the transmission apparatus 2J in the area 4B receives a main signal frame from the transmission apparatus 2D in the area 4A, the transmission apparatus 2J extracts attribute information from the main signal frame. Note that the attribute information includes, as report-destination identification information, an IP address of the originator transmission apparatus 2A defined on the DCN 5 and the circuit ID thereof defined on the OTN 4, and also includes route information identifying a transmission route #A→#D. When the transmission apparatus 2J extracts the attribute information, the transmission apparatus 2J update attribute information in the memory 26 by overwriting the attribute information in the memory 26 with the extracted attribute information.

When the transmission apparatus 2J transmits the main signal frame to a downstream transmission apparatus 2 in the area 4B, the transmission apparatus 2J rewrites report-destination identification information identifying a report-destination transmission apparatus 2 included in the attribute information so that the report-destination identification information indicates an IP address on the DCN 5 and a circuit ID of transmission apparatus 2J as the report-destination transmission apparatus 2, thereby producing new attribute information including the rewritten report-destination identification information and route information identifying a transmission route #A→#D→#J (as denoted by attribution information OH [J/ADJ] in FIG. 6). The transmission apparatus 2J then attaches the new attribute information to the main signal frame and transmits the main signal frame to which new attribute information is attached, to the optical transmission node 10K of the downstream transmission apparatus 2K in the area 4B.

When the transmission apparatus 2K receives the main signal frame from the transmission apparatus 2J, the transmission apparatus 2K updates attribute information in the memory 26 by overwriting the attribute information in the memory 26 with the attribute information attached to the main signal frame. When the transmission apparatus 2K transmits the main signal frame to the transmission apparatus 2 at a downstream location in the area 4B, the transmission apparatus 2K rewrites the route information in the attribute information by adding the transmission apparatus 2K (#K) as a way node to the route information, to produce new attribute information including route information indicating a route #A→#D→#J #K (as denoted by attribution information OH [J/ADJK] in FIG. 6). The optical transmission node 10K of the transmission apparatus 2K then transmits the main signal frame to which the new attribute information is attached, to the optical transmission node 10N of the transmission apparatus 2N.

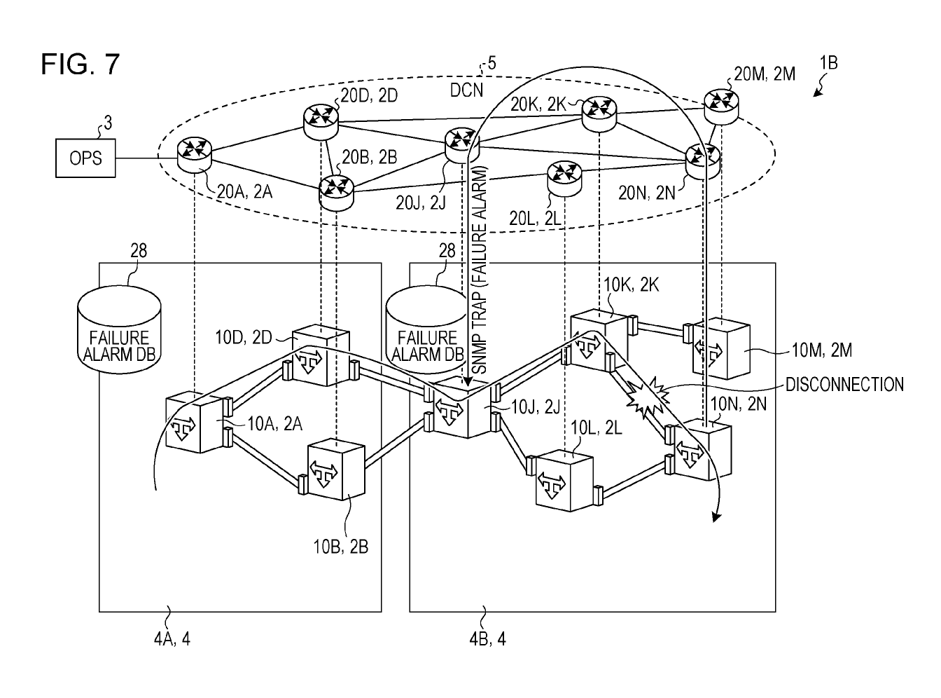

FIG. 7 is a diagram illustrating an example of an operation of an optical transmission system when a failure has occurred, according to a second embodiment. In the example of the optical transmission system 1B illustrated in FIG. 7, it is assumed that a line failure has occurred between the transmission apparatus 2K and the transmission apparatus 2N in the area 4B. When the transmission apparatus 2N detects a failure on the OTN 4, the transmission apparatus 2N sends a failure alarm to the transmission apparatus 2J via the DCN 5 using the SNMP trap function, based on information identifying the transmission apparatus 2J described in the updated attribute information overwritten in the memory 26, that is, based on the IP address of the report-destination transmission apparatus 2.

When the report-destination transmission apparatus 2J receives the failure alarm from the downstream transmission apparatus 2N using the SNMP trap function, the transmission apparatus 2J registers the failure alarm in a failure alarm DB 28. The report-destination transmission apparatus 2J then identifies the line failure between the transmission apparatus 2K and the transmission apparatus 2N based on the contents of the failure alarm message. When the location of the failure is identified, the report-destination transmission apparatus 2J searches the routing table 22 for an alternative route that bypasses the failure. For example, the transmission apparatus 2J issues a command to change the currently-used route to an alternative route: the transmission apparatus 2J→the transmission apparatus 2L→transmission apparatus 2N.

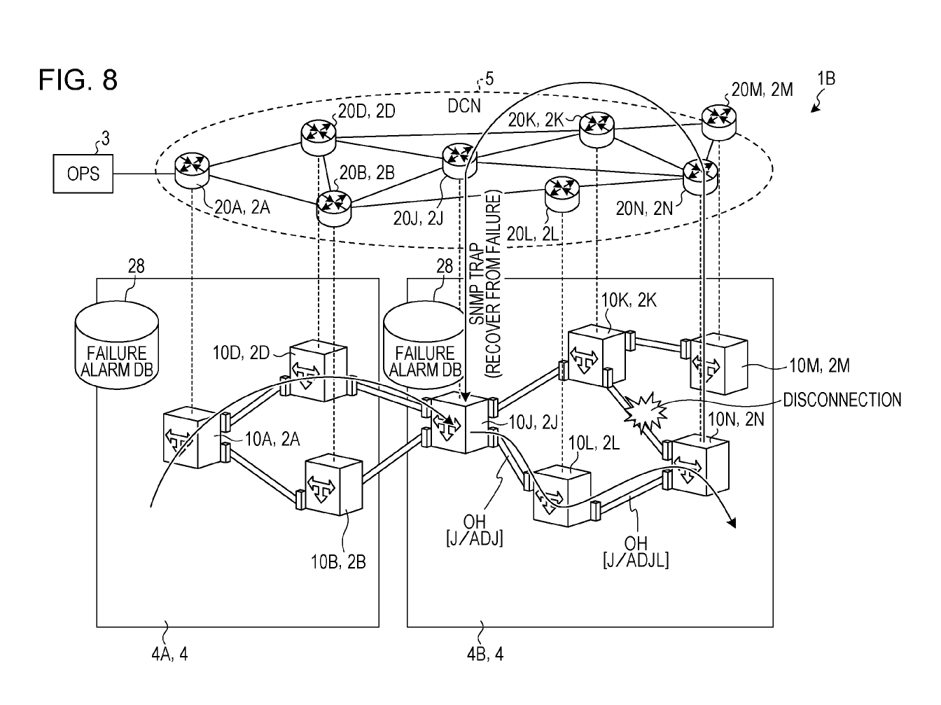

FIG. 8 is a diagram illustrating an example of an operation of an optical transmission system when a failure has recovered, according to a second embodiment. In this case, expression “recovery from a failure” is used to mean that the failure is resolved by using an alternative transmission route. FIG. 8 illustrates an example of an operation of the optical transmission system 1B for a case in which a recovery-from-failure message is issued. In FIG. 8, the report-destination transmission apparatus 2J produces new attribute information including, as report-destination identification information, an IP address and a circuit ID of the transmission apparatus 2J and including route information identifying transmission route #A→#D→#J (as denoted by attribution information OH [J/ADJ] in FIG. 8). Furthermore, the transmission apparatus 2J switches the optical transmission node 10K to the optical transmission node 10L, and the transmission apparatus 2J transmits the main signal frame to which the new attribute information is attached, to the optical transmission node 10L of the transmission apparatus 2L.

When the transmission apparatus 2L receives the main signal frame from the optical transmission node 10J, the transmission apparatus 2L updates attribute information in the memory 26 by overwriting attribute information in the memory 26 with the attribute information attached to the main signal frame. When the transmission apparatus 2L transmits the main signal frame to the transmission apparatus 2N at a downstream location in the area 4B, the transmission apparatus 2L rewrites the route information in the attribute information by adding the transmission apparatus 2L (#L) as a way node to the route information, to produce new attribute information including route information identifying transmission route #A→#D→#3 #L (as denoted by attribution information OH [J/ADJL] in FIG. 8). The optical transmission node 10L in the transmission apparatus 2L then transmits the main signal frame to which the new attribute information is attached, to the optical transmission node 10N.

When the transmission apparatus 2N receives the main signal frame from the optical transmission node 10L, the transmission apparatus 2N updates attribute information in the memory 26 by overwriting attribute information in the memory 26 with the attribute information attached to the main signal frame. At the same time, the transmission apparatus 2N recognizes that the recovery from the failure is complete, and the transmission apparatus 2N sends a recovery-from-failure message to the report-destination transmission apparatus 2J using the SNMP trap function based on the IP address, on the DCN 5, of the report-destination transmission apparatus 2J described in the attribute information.

When the report-destination transmission apparatus 2J receives the recovery-from-failure message from the transmission apparatus 2N at a downstream location via the DCN 5 using the SNMP trap function, the report-destination transmission apparatus 2J deletes the failure alarm registered in the failure alarm DB 28. Thus, the report-destination transmission apparatus 2J recognizes that the recovering from the failure on the OTN 4 is complete.

In the second embodiment, the failure alarm is sent to the transmission apparatus 2J serving as the report-destination transmission apparatus 2 having the function of making recovering from failures regardless of whether the transmission apparatus 2 is the originator of the main signal frame. This makes it possible to minimize the influence caused by, for example, a change in route when recovering from the failure.

Furthermore, in the second embodiment, the OTN 4 is divided into a plurality of areas, and a report-destination transmission apparatus 2 is disposed in each area. This makes it possible to minimize the influence caused by, for example, a change in route when recovering from the failure.

In the second embodiment described above, one report-destination transmission apparatus 2 is provided in each area. Alternatively, a plurality of report-destination transmission apparatuses 2 may be provided in each area.

In the second embodiment described above, the optical transmission system 1B is configured such that one OTN 4 is divided into a plurality of areas, and one report-destination transmission apparatus 2 is provided in each area. However, the technique disclosed above is also applicable to an optical transmission system in which transmission apparatuses 2 in the OTN 4 are connected via a different transmission network, as described below in a third embodiment.

### Third Embodiment

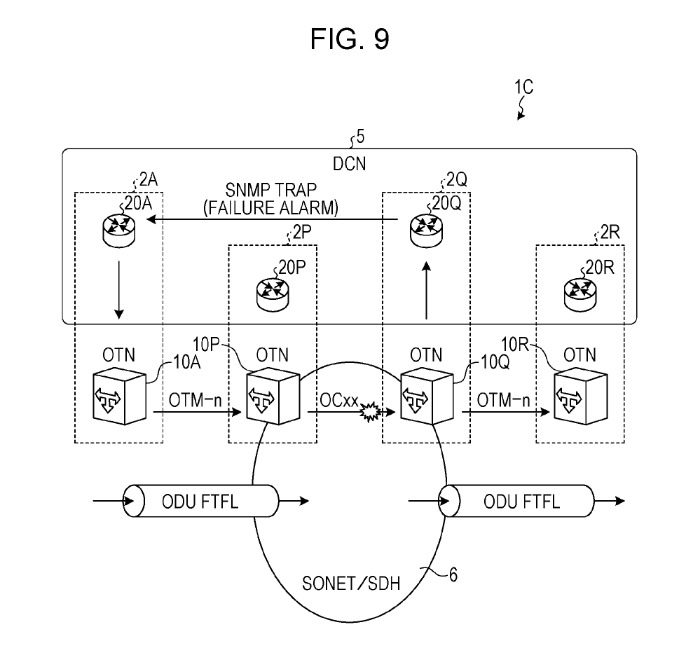

FIG. 9 is a diagram illustrating a configuration example of an optical transmission system, according to a third embodiment. Constituent elements similar to those in the optical transmission system 1 according to the first embodiment are denoted by similar reference numerals or symbols, and a duplicated explanation thereof is omitted here. The optical transmission system 1C illustrated in FIG. 9 includes a transmission apparatus 2A (#A), a transmission apparatus 2P (#P), a transmission apparatus 2Q (#Q), and a transmission apparatus 2R (#R). The transmission apparatus 2A, the transmission apparatus 2P, the transmission apparatus 2Q, and the transmission apparatus 2R are installed in an OTN 4 and communicated with each other in the following manner.

An optical transmission node 10A of the transmission apparatus 2A transmits/receives a main signal frame to/from an optical transmission node 10P of the transmission apparatus 2P. Note that when a failure occurs between the transmission apparatus 2A and the transmission apparatus 2P, the transmission apparatus 2A and the transmission apparatus 2P notifies each other of a location of the failure and the details of the failure using the Fault Type & Fault Location reporting channel (FTFL) function of a main signal frame.

An optical transmission node 10Q of the transmission apparatus 2Q transmits/receives a main signal frame to/from an optical transmission node 1OR of the transmission apparatus 2R. Note that when a failure occurs between the transmission apparatus 2Q and the transmission apparatus 2R, the transmission apparatus 2Q and the transmission apparatus 2R notifies each other of a location of the failure and the details of the failure using the FTFL function of a main signal frame.

The optical transmission node 10P and the optical transmission node 10Q are connected to each other via a transmission network of a different type, for example, Synchronous Optical Network/Synchronous Digital Hierarchy (SONET/SDH) network 6. However, when a failure occurs on the SONET/SDH network 6 between the transmission apparatus 2P and the transmission apparatus 2Q, the transmission apparatus 2P and the transmission apparatus 2Q are not capable of informing each other of the failure using the FTFL function which is not supported by the SONET/SDH network 6.

The transmission apparatus 2A, the transmission apparatus 2P, the transmission apparatus 2Q, and the transmission apparatus 2R each include a control card 20 that allows those apparatuses to perform communication for monitor/control operation via the DCN 5. For example, the transmission apparatus 2A has a control card 20A, the transmission apparatus 2P has a control card 20P, the transmission apparatus 2Q has a control card 20Q, and the transmission apparatus 2R has a control card 20R.

When the transmission apparatus 2A transmits a main signal frame to the transmission apparatus 2P at a downstream location, the transmission apparatus 2A attaches attribute information to the main signal frame. The attribute information includes, as report-destination identification information, an IP address on the DCN 5 and a circuit ID assigned to the transmission apparatus 2A serving as the report-destination transmission apparatus 2, and the attribute information also includes route information of #A. The transmission apparatus 2A transmits the main signal frame to which the attribute information is attached, to the transmission apparatus 2P.

When the transmission apparatus 2P receives the main signal frame from the transmission apparatus 2A at an upstream location, updates attribute information in the memory 26 by overwriting the attribution information in the memory 26 with the attribute information attached to the main signal frame. When the transmission apparatus 2P transmits the main signal frame to the transmission apparatus 2Q at a downstream location, the transmission apparatus 2P rewrites the route information in the attribute information by adding the transmission apparatus 2P (#P) as a way node to the route information, to produce new attribute information including route information identifying transmission route #A #P. The transmission apparatus 2P then transmits the main signal frame to which the new attribute information is attached, to the transmission apparatus 2Q.

When the transmission apparatus 2Q receives the main signal frame from the transmission apparatus 2P at an upstream location via the SONET/SDH network 6, the transmission apparatus 2Q updates attribute information in the memory 26 by overwriting the attribution information in the memory 26 with the attribute information attached to the main signal frame in the memory 26. When the transmission apparatus 2Q transmits the main signal frame to the transmission apparatus 2R at a downstream location, the transmission apparatus 2Q rewrites the route information in the attribute information by adding the transmission apparatus 2Q (#Q) as a way node to the route information, to produce new attribute information including route information identifying transmission route #A→#P→#Q. The transmission apparatus 2Q then transmits the main signal frame to which the new attribute information is attached, to the transmission apparatus 2R.

When the transmission apparatus 2R receives the main signal frame from the transmission apparatus 2Q at an upstream location via the SONET/SDH network 6, the transmission apparatus 2R updates attribute information in the memory 26 by overwriting the attribution information in the memory 26 with the attribute information attached to the main signal frame. When the transmission apparatus 2R transmits the main signal frame to a transmission apparatus 2 at a downstream location, the transmission apparatus 2R rewrites the route information in the attribute information by adding the transmission apparatus 2R (#R) as a way node to the route information, to produce new attribute information including route information identifying transmission route #A→#P→#Q→#R. The transmission apparatus 2R then transmits the main signal frame to which the new attribute information is attached, to the downstream transmission apparatus 2.

When a failure occurs on the SONET/SDH network 6, for example, between the transmission apparatus 2P and the transmission apparatus 2Q, the control card 20Q of the transmission apparatus 2Q sends a failure alarm to the control card 20A of the report-destination transmission apparatus 2A using the SNMP trap function via the DCN 5 based on the IP address of the report-destination transmission apparatus 2A described in the attribute information stored in the memory 26. Thus, the report-destination transmission apparatus 2A receives the failure alarm from the transmission apparatus 2Q at the downstream location using the SNMP trap function. In response, the report-destination transmission apparatus 2A identifies, based on the failure alarm, the location of the failure on the SONET/SDH network 6 between the transmission apparatus 2P and the transmission apparatus 2Q. When there is an alternative route that bypasses the location of the failure identified by the report-destination transmission apparatus 2A, the alternative route is employed to make recovery from the failure.

Thus, in the third embodiment, even when a failure occurs on the SONET/SDH network 6 between transmission apparatuses in the OTN 4, it is possible to send a failure alarm to the report-destination transmission apparatus 2A using the SNMP trap function via the DCN 5 based on the IP address of the report-destination transmission apparatus 2A described in the attribute information. Thus, even if a failure occurs on the SONET/SDH network 6 via which communication is allowed among transmission apparatuses in the OTN 4, the report-destination transmission apparatus 2A is capable of identifying the location of the failure.

In the third embodiment described above, the SONET/SDH network 6 is employed as a transmission network for connecting transmission apparatuses 2 in the OTN 4. Alternatively, transmission networks other than the SONET/SDH network 6 may be employed.

In the first and second embodiments described above, it is assumed by way of example that a main signal frame is transmitted unidirectionally between transmission apparatus 2s. Note that the techniques disclosed above are also applicable to a case where a main signal frame is transmitted bidirectionally between transmission apparatuses 2, as described below in a fourth embodiment.

### Fourth Embodiment

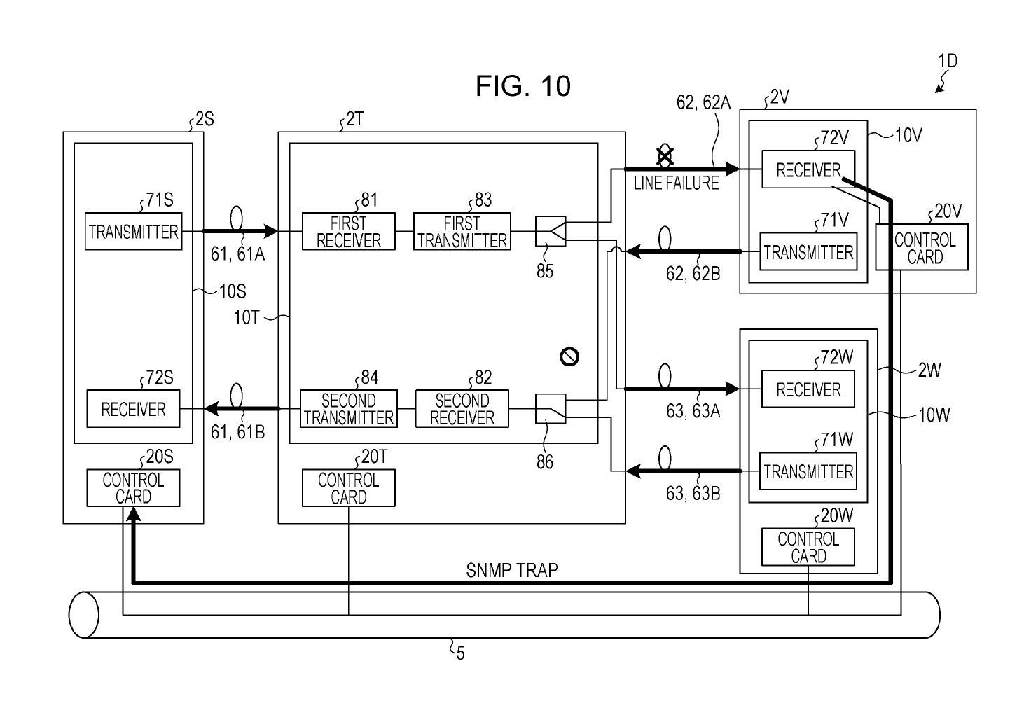

FIG. 10 is a diagram illustrating a configuration example of an optical transmission system, according to a fourth embodiment. The optical transmission system 1D illustrated in FIG. 10 includes a transmission apparatus 2S (#S), a transmission apparatus 2T (#T), a transmission apparatus 2V (#V), and a transmission apparatus 2W (#W). The transmission apparatus 2S communicates bidirectionally with the transmission apparatus 2T via an optical fiber 61. The transmission apparatus 2T communicates bidirectionally with the transmission apparatus 2V via an optical fiber 62. The transmission apparatus 2T communicates bidirectionally with the transmission apparatus 2W via an optical fiber 63.

The transmission apparatus 2S includes an optical transmission node 10S and a control card 20S. The optical transmission node 10S includes a transmitter 71S configured to transmit a main signal frame to the transmission apparatus 2T via the optical fiber 61A and a receiver 72S configured to receive a main signal frame from the transmission apparatus 2T via the optical fiber 61B. The transmission apparatus 2V includes an optical transmission node 10V and a control card 20V. The optical transmission node 10V includes a transmitter 71V configured to transmit a main signal frame to the transmission apparatus 2T via the optical fiber 62B and a receiver 72V configured to receive a main signal frame from the transmission apparatus 2T via the optical fiber 62A. The transmission apparatus 2W includes an optical transmission node 10W and a control card 20W. The optical transmission node 10W includes a transmitter 71W configured to transmit a main signal frame to the transmission apparatus 2T via the optical fiber 63B and a receiver 72W configured to receive a main signal frame from the transmission apparatus 2T via the optical fiber 63A.

The transmission apparatus 2T includes an optical transmission node 10T and a control card 20T. The optical transmission node 10T includes a first receiver 81, a second receiver 82, a first transmitter 83, a second transmitter 84, a photo coupler 85, an optical switch 86, and the control card 20T. The first receiver 81 receives a main signal frame from the transmission apparatus 2S via the optical fiber 61A and transmits the received main signal frame to the first transmitter 83. The first transmitter 83 transmits the main signal frame received via the first receiver 81 to the photo coupler 85. The photo coupler 85 splits the main signal frame received from the first transmitter 83 into light signals for two optical fibers 62A and 63A such that one of split signals is transmitted to the transmission apparatus 2V via the optical fiber 62A and the other of the split signals is transmitted to the transmission apparatus 2W via the optical fiber 63A.

The optical switch 86 selects one of the optical fiber 62B and the optical fiber 63B. When optical fiber 62B is selected, the main signal frame from the transmission apparatus 2V is transmitted to the second receiver 82 via the optical fiber 62B. On the other hand, when the optical fiber 63B is selected by the optical switch 86, the main signal frame from the transmission apparatus 2W is transmitted to the second receiver 82 via the optical fiber 63B. The second receiver 82 receives the main signal frame via the optical fiber 62B or 63B selected by the optical switch 86, and transmits the received main signal frame to the second transmitter 84. The second transmitter 84 transmits the main signal frame received by the second receiver 82 to the transmission apparatus 2S via the optical fiber 61B.

The control card 20S of the transmission apparatus 2S, the control card 20T of the transmission apparatus 2T, the control card 20V of the transmission apparatus 2V, and the control card 20W of the transmission apparatus 2W are capable of communicating with each other for monitor/control operation via the DCN 5.

For example, it is assumed that a line failure has occurred on the optical fiber 62A from the transmission apparatus 2T to the transmission apparatus 2V. In this case, because communication between the transmission apparatus 2T and the transmission apparatus 2V is performed bidirectionally via the optical fiber 62, it is possible for the transmission apparatus 2V to inform the transmission apparatus 2T of the line failure via the optical fiber 62B. However, when the optical fiber 63B has been selected by the optical switch 86 at the transmission apparatus 2T, the line failure notification from the transmission apparatus 2V does not arrive at the transmission apparatus 2S.

In view of the above, when the control card 20V of the transmission apparatus 2V detects a line failure on the optical fiber 62A, the control card 20V sends a failure alarm to the transmission apparatus 2S using the SNMP trap function via the DCN 5 based on the IP address of the report-destination transmission apparatus 2S described in the attribute information. Thus, the transmission apparatus 2S receives the failure alarm using the SNMP trap function, and the transmission apparatus 2S identifies, based on the failure alarm, the location of the failure on the optical fiber 62A between the transmission apparatus 2T and the transmission apparatus 2V. When the transmission apparatus 2S identifies the failure, the transmission apparatus 2S performs a process to make recovery from the failure.

In the fourth embodiment, as described above, even if a line failure occurs in the bidirectional optical transmission system 1D, it is possible to send a failure alarm to the report-destination transmission apparatus 2S at the upstream location via the DCN 5 using the SNMP trap function. Thus the report-destination transmission apparatus 2S is capable of receiving the failure alarm using the SNMP trap function, and capable of identifying the location of the failure based on the received failure alarm.

In the embodiments described above, a failure alarm is sent to a report-destination transmission apparatus 2 via the DCN 5 using the SNMP trap function. However, the transmission network is not limited to the DCN 5, but any transmission network may be employed as long as it has the capability of sending a failure alarm.

In the embodiments described above, the failure alarm includes information indicating the details of the failure. However, the failure alarm may not include information indicating the details of the failure.

Constituent elements of each apparatus/unit illustrated in respective figures may be physically configured differently from those illustrated in the figures. That is, each apparatus/unit may be divided into two or more parts, or all or part of each apparatus/unit may be combined together depending on various loads or a manner in which the system/apparatus is used, i.e., physical or functional units in the system/apparatus may be divided or integrated as desired.

All or any part of processes or functions performed in each apparatus may be executed or implemented on a central processing unit (CPU) or a microcomputer such as a micro processing unit (MPU), a micro controller unit (MCU), or the like. All or any part of processes or functions may be executed or implemented by a program installed on a CPU or a microcomputer such as an MPU, an MCU, or the like configured to execute the program, or all or any part of processes or functions may be executed or implemented by wired logic hard ware.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus for determining a location of failure in a first transmission network, the apparatus comprising:
a termination circuit to:
receive data from a first transmission device that is communicably coupled to the apparatus through the first transmission network, and
extract, from the received data, attribute information that includes report-destination identification information identifying a second transmission device and first route information identifying a transmission route through which the data has been transmitted to the apparatus via the first transmission device in the first transmission network; and
a processing circuit to:
store, in a memory, the attribute information extracted by the termination circuit, and
notify, upon detecting a first failure that has occurred in the first transmission network, the second transmission device of first failure information that indicates an occurrence of the first failure and includes the first route information, based on the report-destination identification information included in the attribute information stored in the memory, through a second transmission network different from the first transmission network.

2. The apparatus of claim 1, wherein
when the processing circuit receives second failure information that indicates an occurrence of a second failure in the first network and includes second route information identifying a transmission route through which the data has been transmitted to a second transmission device that has detected the second failure in the first network, the processing circuit determines a location at which the second failure has occurred, based on the second routing information included in the second failure information, and provides an instruction for recovering from the second failure.

3. The apparatus of claim 1, wherein
the processing circuit, when the termination circuit extracts the attribute information from the data, updates the attribute information by adding information identifying the apparatus to the routing information included in the attribute information; and
the termination circuit adds the attribute information updated by the processing circuit to the data, and transmits the data to which the updated attribute information is added, to a third transmission device that is communicably coupled to the apparatus via the first transmission network and located on a down stream side of a transmission route of the data in the first network.

4. The apparatus of claim 1, wherein
the second transmission device is a transmission device that has originated the data.

5. The apparatus of claim 1, wherein
the second transmission device provides an instruction for recovering from the first failure.

6. The apparatus of claim 1, wherein
the processing circuit transmits the first failure information to the second transmission device using a trap function according to a simple network management protocol (SNMP) implemented in the second transmission network.

7. A method for determining a location of failure in a first transmission network, the method being performed by a first transmission device that receives data from a second transmission device through the first transmission network, the method comprising:
extracting, from the received data, attribute information including report-destination identification information identifying a third transmission device and routing information identifying a transmission route through which the data has been transmitted to the first transmission device via the second transmission device in the first transmission network;
storing the extracted attribute information in a memory; and
notifying, upon detecting a failure that has occurred in the first transmission network, the third transmission device of failure information that indicates an occurrence of the failure and includes the route information, based on the report-destination identification information included in the attribute information stored in the memory, through a second transmission network different from the first transmission network.

8. A system for determining a location of failure in a first transmission network including a plurality of transmission devices, the system comprising:
first and second transmission devices included in the plurality of transmission devices; and
a third transmission device included in the plurality of transmission devices, wherein
the first transmission device is configured to:
receive data from the second transmission device,
extract, from the received data, attribute information including report-destination identification information identifying the third transmission device and routing information identifying a transmission route through which the data has been transmitted to the first transmission device via the second transmission device in the first transmission network,
store the extracted attribute information in a memory, and
notify, upon detecting a failure that has occurred in the first transmission network, the third transmission device of failure information that indicates an occurrence of the failure and includes the route information, based on the report-destination identification information included in the attribute information stored in the memory, through a second transmission network different from the first transmission network.
